(19) United States
(12) Patent Application Publication
(10) Pub. No.: US 2007/0143233 A1
(43) Pub. Date: Jun. 21, 2007

(54) Adaptivity of ambient intelligence to fulfill consumer needs

(75) Inventor: Egidius G.P. Van Doren, Lommel (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 10/575,574

(22) PCT Filed: Oct. 12, 2004
(86) PCT No.: PCT/IB04/52067

§ 371 Date: Apr. 11, 2006

Related U.S. Application Data
(60) Provisional application No. 60/511,246, filed on Oct. 15, 2003.

(51) Int. Cl. G06F 15/18

(52) U.S. Cl. 706/14; 706/16

(57) ABSTRACT

The present invention provides a system and method for a user to set and reset and even turn to zero, the level of heuristically guided behavior exhibited by a consumer electronic (CE) product. A CE product, according to a preferred embodiment of the present invention, exhibits at least one behavior guided by a predetermined heuristic wherein the heuristic can be applied in cumulative steps that increase or decrease or set to zero the level of an exhibited behavior.

The present invention relates to consumer electronic products. More particularly, the present invention relates to consumer electronic products having at least one heuristically determined behavior, i.e. intelligent behavior, that may be applied incrementally. Most particularly, the present invention relates to consumer electronic products allowing a user to its control the level of heuristically determined behavior.

In the future, more and more consumer electronic (CE) products whose intelligent behavior is controlled heuristically, are going to enter the marketplace. One such heuristic is intelligence to learn from users of a product and anticipate the next level of use of the product.

Intelligence-enhanced products will be used by different individuals that appreciate or are comfortable with different levels of heuristically controlled product behavior. And, these comfort levels will evolve over time to a lesser or higher level of heuristic control, or both. A setting (e.g. slider) to determine the intelligence of a product will be needed to allow each user to tune a product's behaviors to the levels desired by the individual user.

The present invention provides a system and method for a user to set and reset and even turn to zero, the level of heuristically guided behavior exhibited by a consumer electronic (CE) product. A CE product, according to a preferred embodiment of the present invention, exhibits at least one behavior guided by a predetermined heuristic wherein the heuristic can be applied in cumulative steps that increase or decrease or set to zero the level of an exhibited behavior.

Further, in an alternative embodiment, a heuristic can include learning from user interaction with the CE product, e.g., from explicit user set and reset inputs to the CE product or by observation of user behavior with respect to the CE product. An intelligent digital video recorder has noticed that yesterday the user has watched a certain soap, and today this soap is also broadcasted. So it has a heuristic that the user might be interested in this soap again. It automatically records this soap. An intelligent CE product will have many of these heuristics to ‘mimic’ intelligence:

Cars store selectable settings for individual users such as seat position and wheel orientation but in the future the car will sense the weight and shape of the individual and automatically adjust these settings and turn on the audio player to a favorite musical recording or a previously selected news station.

How does the favorite become a favorite?—By having a heuristic that keeps track of such things as prior settings for a individual user in a non-volatile on-board memory and retrieving and exhibiting product behaviors based on these prior settings.

All sorts of preferences can be input or learned from behavior of a user that can be observed, and then analyzed and stored to be used to guide future behavior of a CE product. What is needed is giving a user the ability to change the intelligent behavior of the CE product to reflect the user's current preferences. If some (part of) intelligent behavior is annoying then the user can turn off that behavior or decrease it to a tolerable level.

Not only is there a settable and resettable set of values, but, in an alternative embodiment these values can be set and reset for a particular user of an appliance, both prior to and during each use. In this embodiment user values are stored on-board the CE product for a plurality of users with each user being able to select a pre-stored level prior and during to each use, modify the level during use and save the modification as a future usage preference. A usage profile of several such settable and observable variable is also stored in an alternative embodiment, with a plurality of usage profile possible for each user of the CE product.

How the settings are set and visually or verbally presented to the user can be done with all kinds of user interfaces (UIs), comprising a screen with touch or stylus, button with level indicator, variable input slider; on/off knob or photo sensor, verbal command, flat electronic input panel, built-in speaker, infrared or heat sensor, motion detector, and other similar user interfaces.

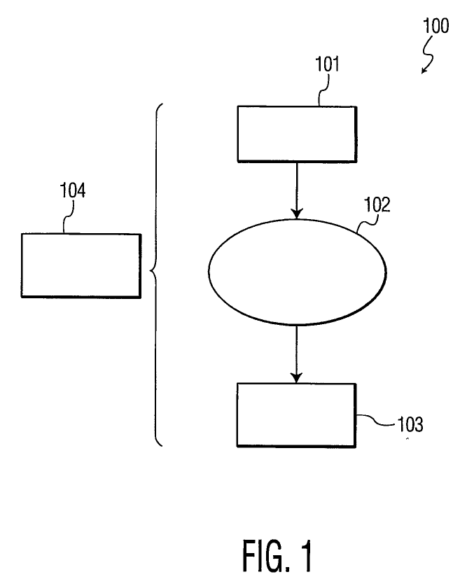

FIG. 1 is a flow chart illustrating the operation steps of a typical user-controlled heuristically guided process in a consumer electronic (CE) product according to an embodiment of the present invention;

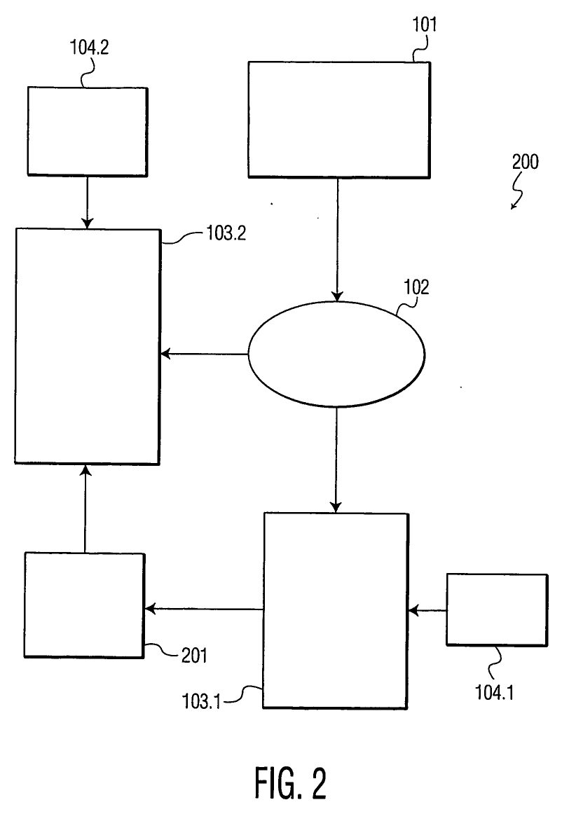

FIG. 2 is a flow chart illustrating the details of the operation steps of FIG. 1 according to a preferred embodiment of the present invention;

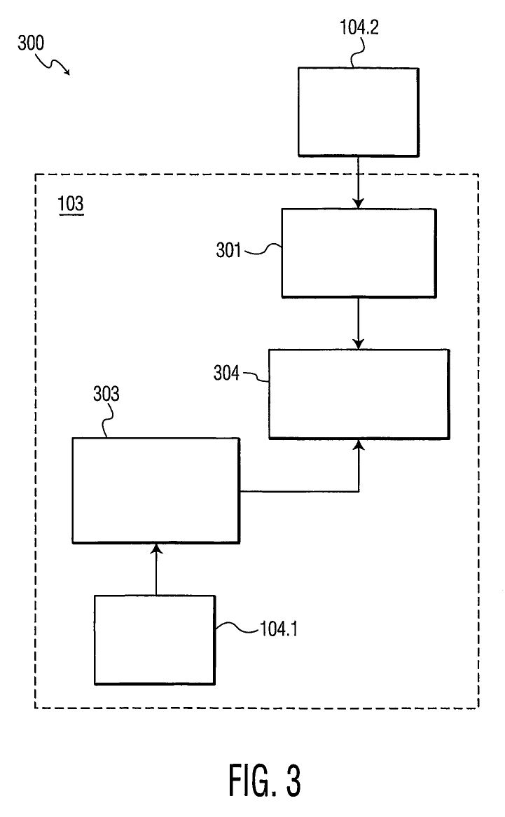

FIG. 3 is a flow chart illustrating the operation steps of processing user inputs and user overrides, i.e., the learning of user preferences by a consumer electronic (CE) product in response to the inputs, according to an embodiment of the present invention; and

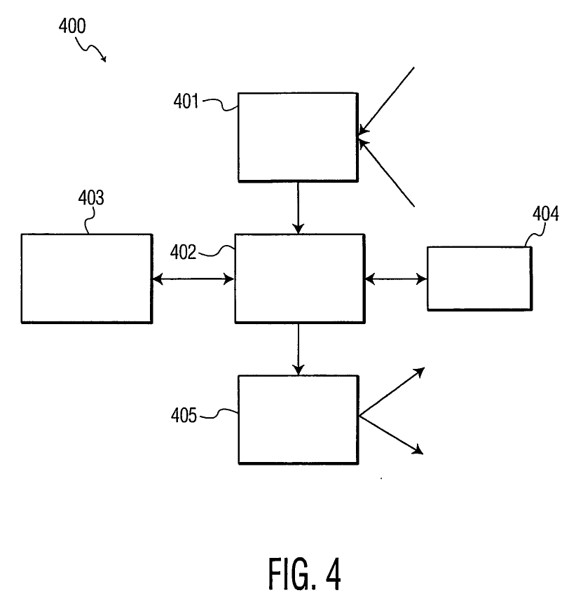

FIG. 4 illustrates a simplified block diagram illustrating the architecture of a consumer electronic (CE) product whereto embodiments of the present invention are to be applied.

It is to be understood by persons of ordinary skill in the art that the following descriptions are provided for purposes of illustration and not for limitation. An artisan understands that there are many variations that lie within the spirit of the invention and the scope of the appended claims. Unnecessary detail of known functions and operations may be omitted from the current description so as not to obscure the present invention.

Toaster Example

Consider the common toaster used by a family of four: Mom, Dad, Sister and Son. Occasionally, house guests use the toaster. The toaster has a manual darkness setting that each user can set. As a user of this toaster, if a current user doesn't pay attention, the current user gets the last user's preference whether the current user likes it or not.

Now suppose the toaster is the toaster of the future with heuristics that determines the darkness setting either by learning user behavior or by accepting user settings and user overrides of prior learning and settings. Suppose there is a storage on-board the toaster for a plurality of user preferences. A user of the toaster of the future may reset the dial to a desired level and, if the heuristic for learning is on, then the toaster finds the closest stored darkness level within a pre-determined tolerance and provides that level as well as other preferences that are stored on-board the toaster. If there is no prior level then the toaster sets up a new user preference or, if learning is off, the toaster takes some other default action.

Alternatively, a user may have an icon or number or other ID for the user's preferred darkness level that can be selected from a display of previously used and stored darkness levels for that user. An example of intelligent learning behavior when a learning heuristic is turned on for a toaster occurs when a user with a certain darkness level preference stored on-board the toaster, reinserts already toasted bread because it was not dark enough and informs the toaster it was not dark enough and is being reinserted, then

the toaster automatically adjusts the user's darkness level preference since it learned that the current preferred darkness setting is not dark enough. If learning is turned off for this heuristic, no adjustment to stored preferences takes place.

In an alternative preferred embodiment, a user can scan all stored settings and select one for the user's preference and can even customize another's settings to create a personal set of preferences to be stored and reused. Note that the preferences are specific to the learning heuristic and that multiple heuristics can be associated with a customizable characteristic of a CE device, e.g., for the toaster two such learning heuristics might be (1) learn a user's preferred darkness setting, and (2) learn to adjust a user's darkness setting by an increment or decrement.

Now consider types of toasted items, e.g., bread v. bagel v. sweet bun. Suppose these can be input to the toaster and entries in the storage made for the user's preferences for these items. Then, when the user enters a new type of item to be toasted the toaster can sense the newness of item and display the user's previous darkness selections and the user can associate the new item with an existing item and its preferences or can enter a new item and a darkness setting.

Shower Example

This scenario is applicable to all sorts of CE products, e.g., hot water level for a shower, tub, or hand held spray; sound level of an audio device; brightness, contrast, and focus of a video screen. Showers can turn on when you step in, sense who a user is from a user's body characteristics or be given and ID and all the user's personal adjustments can be implemented, with the ability for the user to override any and all settings. And these favorite settings can be automatically determined (or adjusted by learning) in the first place by the CE product. An example of a learning heuristic is time sensitive adjustment to the temperature of the water: after X minutes lower the temperature to Y where X and Y are input explicitly by the user or by the shower remembering how the user adjusted the temperature during the user's most recent shower.

FIG. 1 illustrates a representative logic flow for a preferred embodiment of a CE product having a single heuristic 100, i.e., a single settable/resettable/learnable preference. A CE product having a plurality of heuristics would use this logic flow 100 for each heuristic. A user input or external event is received at 101 and can be explicitly provided by the user, sensed by the CE product, or can be a default in case no explicit input of any type is provided. Given the input from 101, the CE product performs an action heuristic at 102 to obtain any stored preferences corresponding to the input or to determine that there is no stored preference. Then the CE product executes some predetermined action with respect to the input and stored preferences at 103. At any point during this process, the user can intercede with an override 104, such as a new input or turning on/off the heuristic's action for this use of the CE product or until reenabled by the user.

FIG. 2 illustrates the heuristic of FIG. 1 instantiated for a shower 200.

At 101, user input is provided and comprises any one or more of a user ID, finger or palm print, retina image, face image, body characteristic (height, weight, outline), etc. Based on the user input a search for user preferences is undertaken at 102. If a user profile is a sufficiently close match then at 103.1 the stored setting are retrieved and used to set the behavior of the CE product. Any user overrides provided at 104.1 are ‘learned’ at 201, including turning the heuristic on/off and collected together in a new user profile at 103.2 and stored on-board for future reference. If, at 102, a corresponding user profile is not found then user inputs and preferences are collected in a new user profile, with any user selections input at 104.2 overriding defaults and then the new user profile is stored at 103.2. Since there is no prior behavior stored for this user, the new profile is a base for learning future behavior.

FIG. 3 illustrates a preferred embodiment of a CE product learning user behavior from user overrides 104.1, 104.2 and stored profiles 301-2. Given a base user profile with a number of preferences (may be a default set of preferences), a user may update 104.1 104.2, i.e., override, any preference and the CE product exhibits the behavior corresponding to the updated set of preferences 304. This updated set of preferences has a likelihood of being the most preferred by the user based on the total number of times the user has used the CE product exhibiting the behavior represented by the profile. If a user overrides a previous preference, a new preference is stored with an updated preferability to make it the most preferable choice 303 and the original likelihood of the overridden profile is retained thus making it less preferred. Any number of preference profiles can be retained for a user so long as there is sufficient non-volatile on-board memory. The preferability is really a figure of merit reflecting the user's most recent choices so that the most recent choices are selected over previously overridden choices. From the stored profile a user can return to a prior choice, making it the most preferred, and can even edit and delete a preference in a further alternative embodiment.

It is possible for a single adjustable characteristic to have a plurality of associated learning heuristics, and for a single CE product to have a plurality of adjustable characteristics. In a preferred embodiment each characteristic can have a plurality of profiles, with a most preferred profile. Each profile stores a complete set of user preferences for all heuristics of all adjustable characteristics, e.g. toaster darkness has a preferred setting and a preferred delta if not satisfactory (maybe a plus and minus captured during prior uses of the toaster when darkness was not satisfactory).

Referring to FIG. 4, the CE product incorporating the heuristics illustrated in FIGS. 1-3 may include a system with an architecture that is illustrated n the block diagram of FIG. 4. A CE product may include an input device 401 comprising at least one of a microphone button, slider, touchpad, touchscreen, keyboard, camera, and sensor for user input; a heuristic logic device 402 for executing the process steps of FIGS. 2-3 for at least one heuristic; a timer device 404 connected to the heuristic logic device 402 and used thereby to record the time at which a user used the CE device and for how long, among other uses; a non-volatile storage 403 connected to the heuristic logic device 402 for long-term storage of, among others, user preference profiles; and an output device connected to the heuristic logic device 402 for providing feedback and output to a user in the form of text, audio, video, beeps and flashes, among others.

How the heuristics are presented to the user depends on the sophistication of the CE product. A CE product can incorporate the following:
a single heuristic for ‘intelligence’ with only one setting for each product (e.g., darkness level);
different categories of a single ‘intelligence’ (several levels of single setting, e.g., darkness for white bread, English muffins, bagels); and
separate heuristics having one or more categories (lots of settings having one or more levels, e.g., darkness: preferred level and retoast +/−adjustment; water temperature: initial value and elapsed-time cooler value).
   Note that some heuristics can be automatic while others require a user input, e.g., retoast needs to be activated somehow and a +/−adjustment captured somehow whereas water temperature adjustment can be sensed and recorded so long as learning is enabled for this heuristic.

While the preferred embodiments of the present invention have been illustrated and described, it will be understood by those skilled in the art that various changes and modifications may be made, and equivalents may be substituted for elements thereof without departing from the true scope of the present invention. In addition, many modifications may be made to adapt the teaching of the present invention to a particular situation without departing from its central scope. Therefore it is intended that the present invention not be limited to the particular embodiments disclosed as the best mode contemplated for carrying out the present invention, but that the present invention include all embodiments falling within the scope of the appended claims.

1. A method for configuring an adaptive device according to user needs, comprising:
providing at least one adaptable characteristic having at least one setting and at least one learning heuristic for the determination of said at least one setting, said heuristic having an enable/disable mode;
initializing said at least one setting to a previously learned user preference and said enable/disable mode to a previously input mode, if any, or respectively to pre-determined default preference setting and mode setting, otherwise;
for said at least one adaptable characteristic, continuously performing the steps of:
(i) accepting a first user input for said at least one setting and a second user input for the enable/disable learning mode for said at least one learning heuristic of said at least one setting,
(ii) based on said second user input, determining a user preference as
the accepted first user input if said mode is disable learning, and
a learned user preference derived by application of the at least one
learning heuristic to the accepted first user input, otherwise, and
(iii) making the at least one setting equal to the determined user preference.

2. The method of claim 1, further comprising the steps of:
providing a user interface for user input and device output; and
said continuously accepting step (i) further comprises the step of accepting the first and second user input via said provided user interface.

3. The method of claim 2, further comprising the step of providing said user interface device as:
an output mechanism comprising at least one of a text display, audio device, video device, a beeping device, and a flashing device, and
an input mechanism comprising at least one of a microphone, button, slider, touchpad, touchscreen, pen device, camera, sensor and keyboard.

4. The method of claim 1, wherein:
said initializing step further comprises the steps of—
receiving a unique user identifier, and
searching a memory on-board the device for at least one previously learned user preference for the at least one setting of the at least one adaptable characteristic corresponding to the received user identifier; and
said learning step further comprises the step of storing in the on-board memory of the device said learned user preference identified by said unique user identifier for said at least one setting of the at least one adaptable characteristic.

5. The method claim 4, wherein said storing step further comprises the steps of:
providing a stored user profile corresponding to the received user identifier; and
storing said learned user preference including a preference level as part of said provided user profile and having the preference level set to ‘most preferable’.

6. The method claim 5, further comprising the steps of:
providing a user interface for user input and device output; and
said continuously accepting step (i) further comprises the step of accepting the first and second user input via said provided user interface.

7. The method of claim 6, further comprising the step of providing said user interface device as
an output mechanism comprising at least one of a text display, audio device, video device, a beeping device, and a flashing device, and
an input mechanism comprising at least one of a microphone, button, slider, touchpad, touchscreen, pen device, camera, sensor and keyboard.

8. The method of claim 6, wherein said accepting step (i) further comprises the steps of:
selecting a previously stored preference for said at least one setting;
optionally, editing said selected previously stored preference; and
inputting as said first user input said edited preference.

9. The method claim 4, further comprising the steps of:
providing a user interface for user input and device output to the user; and
said continuously accepting step (i) further comprises the step of accepting the first and second user input via said provided user interface.

10. The method of claim 9, wherein said accepting step (i) further comprises the steps of:
selecting a previously stored preference for said at least one setting;
optionally, editing said selected previously stored preference; and
inputting as said first user input said edited preference.

11. The method of claim 9, further comprising the step of providing said user interface device as:
an output mechanism comprising at least one of a text display, audio device, video device, a beeping device, and a flashing device, and
an input mechanism comprising at least one of a microphone, button, slider, touchpad, touchscreen, pen device, camera, sensor and keyboard.

12. An adaptive device, comprising:
at least one adaptable characteristic having at least one setting and at least one learning heuristic for the determination of said at least one setting, said heuristic having an enable/disable mode;
an heuristic component configured to:
set said at least one characteristic to at least one previously learned user preference and said enable/disable mode to a previously input mode, if any, or respectively to a pre-determined default preference setting and mode setting, otherwise;
continuously receive a first user input for said at least one setting and a second user input for the enable/disable learning mode of the at least one learning heuristic of said at least one setting; and
reset said at least one setting to the first user input;
a learning module that, if said second user input is enable mode, is configured to learn a user preference for said at least one setting from the first user input according to said at least one learning heuristic of said at least one setting.

13. The apparatus of claim 12, further comprising providing a user interface for user input and device output.

14. The apparatus of claim 13, wherein said user interface is configured as:
an output mechanism comprising at least one of a text display, audio device, video device, a beeping device, and a flashing device, and
an input mechanism comprising at least one of a microphone, button, slider, touchpad, touchscreen, pen device, camera, sensor and keyboard.

15. The apparatus of claim 13, further comprising:
a non-volatile memory; and
wherein, said control component if further configured to:
receive a unique user identifier via the use interface, and
search the non-volatile memory for at least one previously learned user preference for the
at least one setting corresponding to the received user identifier; and
wherein, said learning module is further configured to store said learned user preference identified by said unique user identifier for said at least one setting in the non-volatile memory.

16. The apparatus of claim 15, wherein the learning module is further configured
to: provide a stored user profile in said non-volatile memory corresponding to the user identifier; and
store said learned user preference including a preference level as part of said provided user profile having the preference level set to ‘most preferable’.

17. The apparatus of claim 16, wherein said component is configured to:
select a previously stored preference for said at least one setting;
optionally, edit said selected previously stored preference; and
store edited preference in the non-volatile memory as the most preferred.
